(19) United States
(12) Patent Application Publication
(10) Pub. No.: US 2012/0256862 A1
(43) Pub. Date: Oct. 11, 2012

(54) TOUCHSCREEN GUIDE

(76) Inventor: KURT WAGNER, Urbana, IL (US)

(21) Appl. No.: 13/443,276

(22) Filed: Apr. 10, 2012

Related U.S. Application Data
(60) Provisional application No. 61/516,935, filed on Apr. 11, 2011.

(51) Int. Cl. G06F 3/041

(52) U.S. Cl. 345/173

(57) ABSTRACT

The invention provides a touchscreen guide that directs or limits a user's touch to a target area on the touchscreen of an electronic device.

### CROSS-REFERENCE TO RELATED APPLICATIONS

This application claims priority to U.S. provisional application No. 61/516,935 filed Apr. 11, 2011, the contents of which are incorporated by reference herein in their entirety.

### BACKGROUND

Touchscreen devices combine the dual functions of both data input and display. Rather than requiring a separate keyboard or control in addition to a display screen, the touchscreen incorporates both of these elements. As a result of this unique two-in-one functionality, touchscreens are rapidly gaining popularity and have been utilized in a variety of applications, including computer terminals, gaming devices, navigation systems and cash registers, to name a few.

Touchscreens respond to the touch of their user's finger or other passive objects, such as a stylus. Often, these touchscreen devices are used for playing games or performing other activities that involve the appearance of and image of a joystick, control, or other command-related virtual buttons on the screen of the device. The user controls the software or plays the game by touching the virtual control or buttons on the screen.

Touch screens are smooth, often causing the user's fingers to slip off the surface. In addition, because touchscreens engage both the user's visual and tactile senses, users who are concentrating elsewhere on the screen may hit the wrong button or miss the area of the screen where the control is located altogether because they cannot actually feel where the buttons are located.

One solution to this problem is installation of software or hardware on the device that causes it to vibrate or make a sound when the user's touch is no longer in the target area on the touchscreen. However, for touchscreen devices already in manufacture and those currently distributed on the market, there exists a need for an external solution to the problem that does not involve the modification of the internal operations of the device itself.

### SUMMARY

The invention relates to an accessory for touchscreens on electronic devices. The invention provides a tactile guide that is removably attached to the touchscreen. The touchscreen guide directs the user's fingers or stylus to a predetermined area on the screen by providing a tactile or haptic sensation to the user. It allows the users to direct their touch to a predetermined target area of the touchscreen without needing to look at the predetermined target area. By providing tactile feedback, the touchscreen guide also functions to contain the user's finger to a specific location. Thus the touchscreen guide can facilitate the user's awareness of the target region, while also allowing for visual concentration elsewhere on the screen.

In one aspect, the invention provides a touchscreen guide for demarcating a target area on an electronic touchscreen, the touchscreen guide forming a raised border substantially surrounding the target area. The touchscreen guide has a tactile surface that provides tactile feedback to the user indicating the presence of the target area, or that the user is within the target area, and an attaching base that removably attaches the touchscreen guide to the touchscreen.

In some embodiments, the touchscreen guide forms a circular, oval or elliptical border surrounding a target area. In other embodiments, the touchscreen guide forms a square or rectangular border surrounding a target area. In some embodiments, the square border or rectangular border has rounded corners. In some embodiments, the touchscreen guide forms a polygonal border surrounding the target area. In some embodiments, the polygonal border has rounded corners.

In some embodiments, the tactile surface of a touchscreen guide of an invention has an outer-side, inner-side and top in which the outer-side and inner-side are oriented at about 90 degrees relative to the top. In some embodiments, the outer-side and inner-side are joined to the top at rounded corners. In some embodiments, the tactile surface of the touchscreen guide has a curved shape. In some embodiments, the touchscreen guide forms an arch substantially surrounding a target area. In some embodiments, the touchscreen guide forms a horseshoe arch, elliptical arch, or parabolic arch.

In some embodiments, the touchscreen guide has a tactile surface that is made of a metallic material and/or aluminum.

In some embodiments, the touchscreen guide has an attaching base that is made of rubber. In some embodiments, the attaching base is made of neoprene rubber, isoprene rubber, silicone rubber, natural rubber, or any combination of these.

In some embodiments, the tactile surface and attaching base are secured one to the other using an adhesive. In some embodiments, the tactile surface has a groove along its underside for insertion of the attaching base, which has a ridge for insertion into said tactile surface.

In some embodiments, the tactile surface of a touchscreen guide of the invention has a curved cross section. In some embodiments, the attaching base of a touchscreen of the invention has a curved underside that enables removable attachment of the touchscreen guide to the touchscreen by suction. In some embodiments, the touchscreen guide has an attaching base with a microsuction film for removable attachment of the guide to the touchscreen.

In one aspect, the invention provides a touchscreen guide, i.e. a tactile boundary that substantially surrounds a target area on the screen. In some embodiments, the invention provides a touchscreen guide that is made of an upper boundary and a soft base. In some embodiments, the soft base removably attaches to the touchscreen, and the upper surface provides tactile feedback to the user indicating the location of the target area.

Any feature or combination of features described herein are included within the scope of the present invention provided that the features included in any such combination are not mutually inconsistent as will be apparent from the context, this specification and the knowledge of one of ordinary skill in the art. Unless otherwise defined, all technical and scientific terms used herein have the same meaning as commonly understood by one of ordinary skill in the art to which this invention belongs. In case of conflict, the present specification, including definitions, will control. In addition, the materials, methods, and examples are illustrative only and not intended to be limiting. Although methods and materials similar or equivalent to those described herein can be used to practice the invention, suitable methods and materials are described below.

All patents and publications referenced or mentioned herein are indicative of the levels of skill of those skilled in the art to which the invention pertains, and each such referenced patent or publication is hereby incorporated by reference to the same extent as if it had been incorporated by reference in its entirety individually or set forth herein in its entirety. Applicants reserve the right to physically incorporate into this specification any and all materials and information from any such cited patents or publications.

Other features and advantages of the invention will be apparent from the following detailed description and from the claims.

### BRIEF DESCRIPTION OF THE DRAWINGS

FIGS. 1A-1E are drawings illustrating one embodiment of a touchscreen guide of the invention. FIG. 1A shows the tactile surface 110 and attaching base 120. FIG. 1B is a rear perspective view of the rectangular shape touchscreen guide 100, while FIG. 1C is a front perspective view of touchscreen guide 100. FIG. 1D illustrates an electronic device 130 with a touchscreen 140, the touchscreen 140 having a selected target area 150 on which the touchscreen guide is placed as shown in FIG. 1E.

FIGS. 2A-2C are drawings illustrating three embodiments of a touchscreen guide of the invention. FIG. 2A depicts touchscreen guide 200A having a square shape and rounded corners. FIG. 2B depicts touchscreen guide 200B having a circular shape, and FIG. 2C depicts touchscreen guide 200C having an elliptical shape.

FIGS. 3A-3C are drawings illustrating three embodiments of a touchscreen guide of the invention. FIG. 3A depicts touchscreen guide 300A having the shape of an elliptical arch that substantially surrounds target area 350A in the lower center of touchscreen 340A. FIG. 3B depicts touchscreen guide 300B having the shape of a horseshoe arch that substantially surrounds target area 350B in the lower center of touchscreen 340B. FIG. 3C depicts touchscreen guide 300C having the shape of a parabolic arch that substantially surrounds target area 350C in the lower center of touchscreen 340C.

FIGS. 4A-4F are cutaway views of various embodiments of a touchscreen guide of the invention obtained by taking a vertical cross-section along line 1-1 as illustrated in FIG. 6. The cutaway views illustrate that a touchscreen guide of the invention can have a vertical cross-section having a square shape with rounded corners (FIG. 4A), a square-like shape with three equal sides and a rounded top (FIG. 4B), a rectangular shape with rounded corners (FIG. 4C), a rectangular-like shape with three straight sides and a rounded top (FIG. 4D), a half-circle (FIG. 4E) or an irregular shape characterized by rounded upper portion 412F-1 and curved lower portion 412F-2 (FIG. 4F).

FIGS. 5A-5D are drawings illustrating the partial, vertical cross-sections of various embodiments of the invention obtained along line 1-1 as shown in FIG. 6. FIG. 5A shows that an embodiment in which the touchscreen guide is constructed as one unit having an upper tactile surface 510A and lower attaching base 520A. FIG. 5B shows an embodiment in which the touchscreen guide is assembled from two components, the upper tactile surface 510B having a groove within which the flared, lower attaching base 520B is inserted. FIG. 5C shows an embodiment in which the touchscreen guide is composed of the upper tactile surface 510C secured to the lower attaching base 520C using any means including adhesive or silicon gel. FIG. 5D shows an embodiment in which the touchscreen guide is composed of the upper tactile surface 510D secured to the lower attaching base 520D of similar width to the upper tactile surface 510D using any means including adhesive or silicon gel.

FIG. 6 is a view of an embodiment of a touchscreen guide of the invention that includes the plane upon which a cross section can be taken to generate the cutaway views and partial cross-sections shown in FIGS. 4 and 5, respectively.

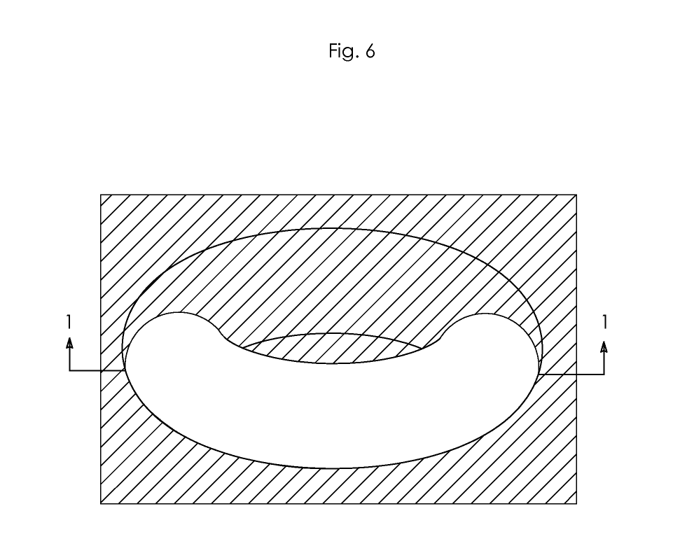

### DETAILED DESCRIPTION

The invention provides a touchscreen guide for use on electronic devices. The invention is based on the discovery that a touchscreen guide can be used to direct or contain a user's fingers or stylus to a predetermined area on a touchscreen. The invention provides a removable guide in the form of a raised, stationary border surrounding a selected area on a touchscreen. The removable guide has a tactile surface, an attaching base, and no moving parts. The tactile surface forms a raised border surrounding or substantially surrounding a selected target area on the touchscreen, and as such, it directs and/or contains the user's fingers or a stylus to the target area. The attaching base removably secures the tactile surface to a selected area on the touchscreen.

The touchscreen guide can form a border of any shape surrounding or substantially surrounding a selected target area on a touchscreen. The target area can have a target periphery that is a rectangle, a square, a circle, a star, a cross, a Maltese cross, a uniform polygon, a nonuniform polygon, a curve, an arc, a line, a convex polygon, a linear curve, or a nonlinear curve. The target area can be located near the side, center, any one corner of the touchscreen, or any location on the touchscreen.

Independent of the shape of the target area, the touchscreen guide or border surrounding a selected area can be circular, oval, or elliptical. The touchscreen guide forming a border surrounding a selected area can have four or more equal or unequal sides including, for example, a square, rectangular, or the shape of any polygon. When the touchscreen guide has four or more equal or unequal sides, the corners can be rounded or pointed. The touchscreen guide can have a vertical cross-section represented by two equal circles, half circles, squares, rectangles, or any polygonal shapes having equal or unequal sides that have rounded corners or corners of any angles. Where the touchscreen guide substantially surrounds a selected area, the guide need not completely enclosed the selected area so long as it sufficiently demarcates the target area so as to signal to the user that he is within the target area. Thus, the touchscreen guide may take a variety of different shapes in an open or closed configuration including, for example, square, rectangular, oval, arched, semi-circular, circular, or in the shape of a cross bar or any other suitable shape. Thus, the guide can have the shape of a ring with the tactile surface having a circular shape. The guide can have the shape of an arch or half circle, such as a horseshoe arch, elliptical arch, or parabolic arch.

The tactile surface of the touchscreen guide can be composed of any material including metal, plastic, rubber, wood, bamboo, or any other material that can provide sufficient tactile feedback to the user. The tactile surface can be composed of one or more materials, such as, for example, aluminum and/or plastic.

The attaching base can be composed of any material including soft plastic, rubber, elastomer, silicone or any other material that enables removable attachment to the touchscreen. The attaching base can be composed of one or more materials that facilitate attachment to the touchscreen via microsuction. The attaching base can be composed of a variety of polymers. For example, the attaching base can be made of rubber such as, without limitation, isoprene, latex, neoprene, polysufide, polyurethane, silicone, natural rubber, thermal plastic rubber or any combination thereof. The attaching base can also be made of a synthetic rubber such as, without limitation, ethylene propylene diene monomer (EPDM) rubber, fluoroelastomer, styrene-butadiene rubber (SBR), and fluorosilicone.

In some embodiments, the tactile surface and attaching base are the top and underside of a single continuous unit rather than two components manufactured separately and secured together. In this case, the touchscreen guide can be composed of a material with softness that varies between two surfaces.

Where the touchscreen guide is composed of a tactile surface to which an attaching base is secured, the attaching base can be a gasket of the same shape as the touchscreen guide. The attaching base can be secured to the tactile surface using any means including adhesive, silicon gel, or direct molding. The attaching base can be flared or collared on its top to enable attachment to a tactile surface with a groove or notch. The attaching base can be die cut from rubber and then attached to the tactile surface or directly molded to the underside of the tactile surface. The attaching base can be curved on its bottom to enable attachment to a touchscreen via suction.

The touchscreen guide can be used to provide tactile feedback to the user with respect to the location and periphery of a selected target area on a touchscreen. For example, the user selects a target area on a touchscreen and places the touchscreen guide on the touchscreen, aligning the touchscreen guide so that it substantially encloses the target area. To attach the touchscreen guide to the touchscreen, the user presses the touchscreen guide against the touchscreen, thereby removably attaching the touchscreen guide to the touchscreen. The tactile surface of the touchscreen then can provide tactile feedback to the user so that the user will be aware of the location and periphery of the selected target area without needing to look at the target area. The touchscreen guide can be detached from the touchscreen after use.

Specific embodiments of the invention are described in the following examples, which do not limit the scope of the invention described in the claims.

### Examples

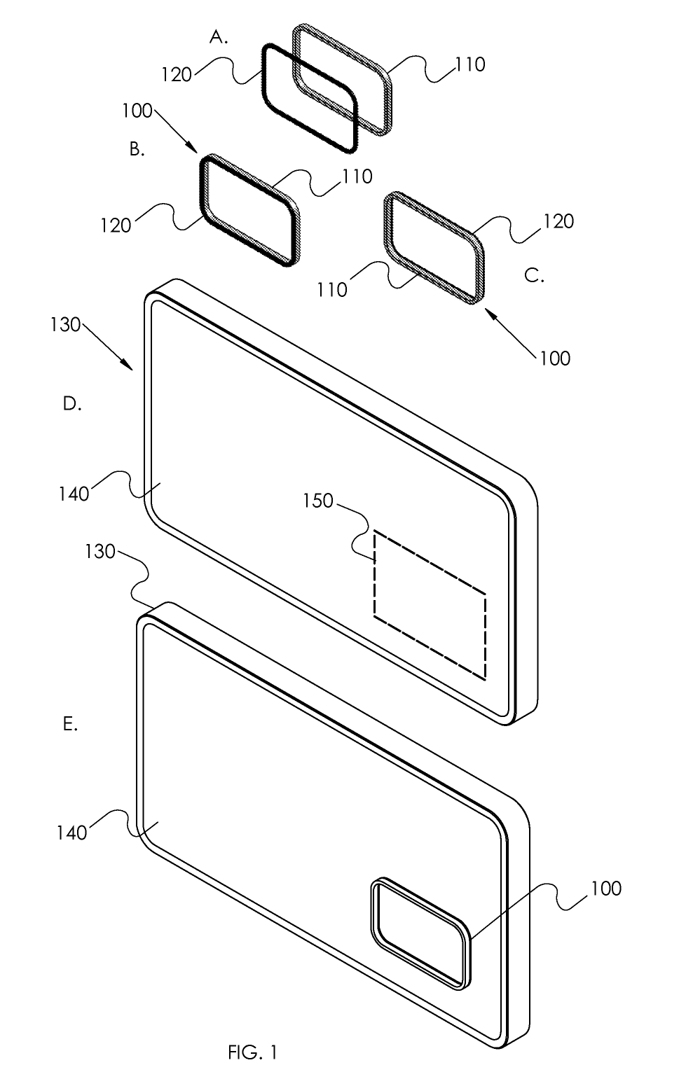

FIGS. 1A-1C show various perspectives of touchscreen guide 100 according to one embodiment of the invention. The touchscreen guide 100 provides a rectangular-shaped border around a selected area. The touch screen guide 100 is composed of a tactile surface 110 and attaching base 120 secured to the underside of the tactile surface 110. FIG. 1B is a perspective view of touchscreen guide 100 from the underside, while FIG. 1C is a perspective view from the top of touchscreen guide 100. The attaching base 120 can be secured to the tactile guide 110 with an adhesive or silicone gel. FIG. 1D shows an electronic device 130 with a touchscreen 140 and a target area 150. The target area 150 is that area of the touchscreen 140 where a particular set of controls are displayed on the touchscreen 140. FIG. 1D shows the target area 150 located near the side of the touchscreen 140, on which the touchscreen guide 100 is placed as shown in FIG. 1E.

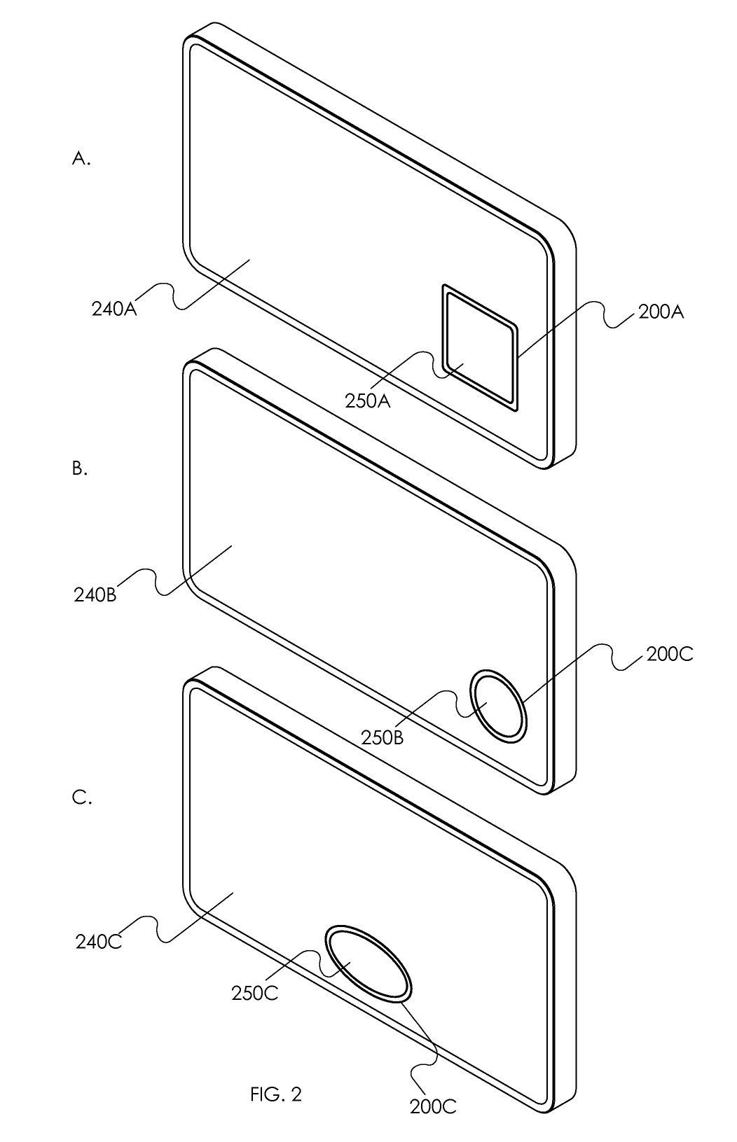

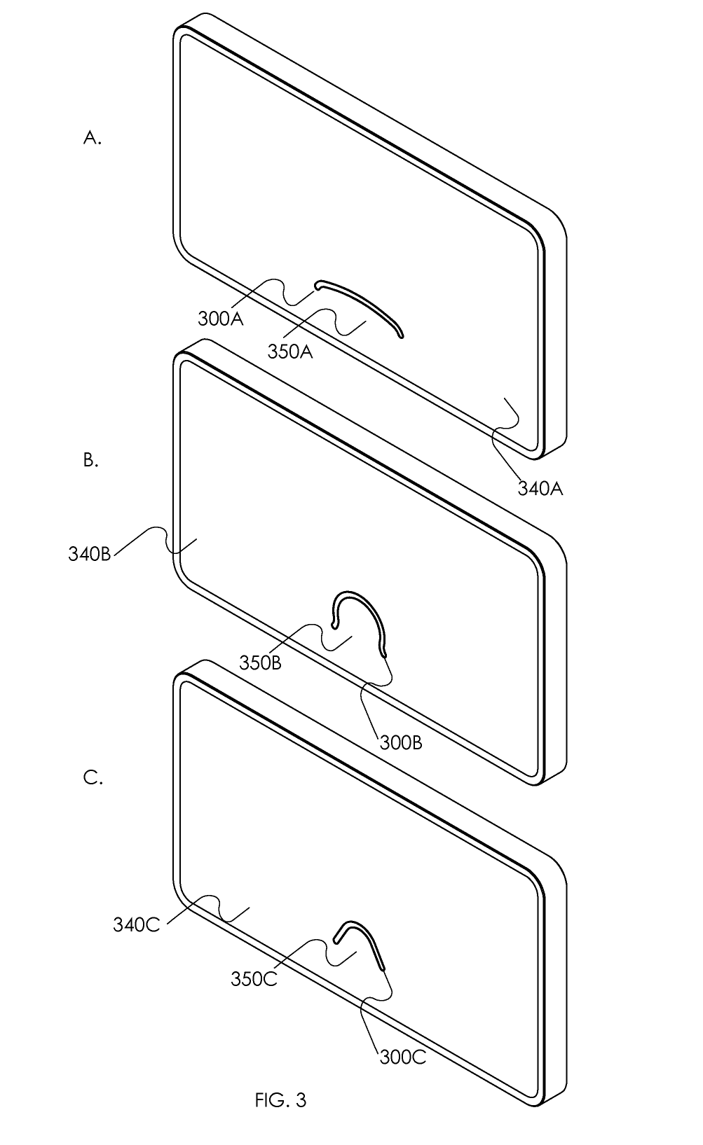

The shapes of various embodiments of a touchscreen guide of the invention are illustrated in FIGS. 2 and 3. In FIG. 2A, touchscreen guide 200A is square in shape and has round corners. Touchscreen guide 200B shown in FIG. 2B is circular in shape, while touchscreen guide 200C shown in FIG. 2C is elliptically shaped. In FIG. 3A, touchscreen guide 300A forms a border in the shape of an elliptical arch that substantially surrounds target area 350A near the center bottom of the touchscreen 340A. In FIG. 3B, touchscreen guide 300B forms a border in the shape of a horseshoe arch that substantially surrounds target area 350B near the center bottom of the touchscreen 340B. In FIG. 3C, touchscreen guide 300C forms a border in the shape of a parabolic arch that substantially surrounds target area 350C near the center bottom of the touchscreen 340C.

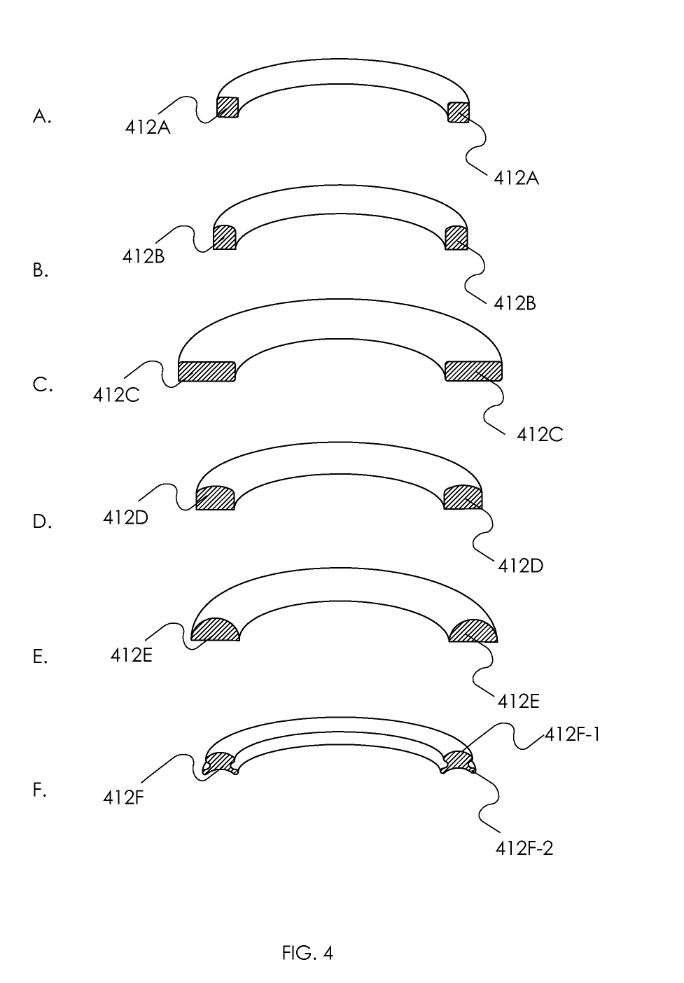

The vertical cross-sections of a touchscreen guide of the invention can also have various shapes as can be seen in the cutaway views illustrated in FIGS. 4A to 4F. In these figures, the vertical cross sections of six embodiments of a touchscreen guide of the invention are represented by the hatched ends. FIGS. 4A to 4F show that the vertical cross-section of a touchscreen guide of the invention can be represented by two squares 412A with rounded corners (FIG. 4A); two square-like shapes, each with a rounded top (FIG. 4B); two rectangles with rounded corners (FIG. 4C); two rectangle-like shapes, each with a rounded top (FIG. 4D); two half circles (FIG. 4E); and two irregular shapes 412F, each with a rounded upper portion 412F-1 and a curved lower portion 412F-2 (FIG. 4F).

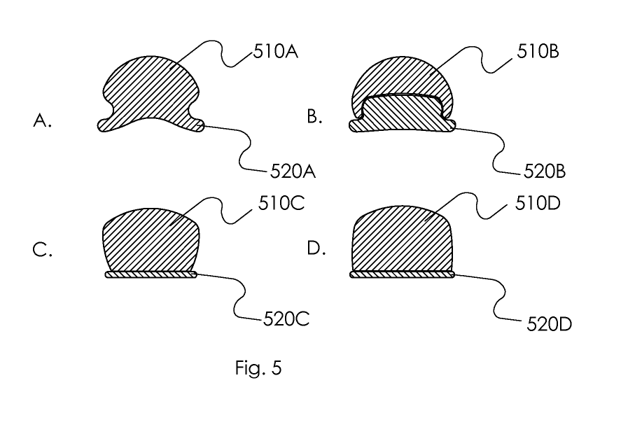

A touchscreen guide of the invention can be constructed as one unit having a tactile surface and an attaching base. Alternatively, a touchscreen guide can be constructed from two components—a component that forms the tactile surface and a component that forms the attaching base—assembled together in various ways. FIGS. 5A to 5X illustrate the partial cross-sections of various embodiments of a touchscreen guide of the invention. In FIG. 5A, the touchscreen guide is constructed as one unit having tactile surface 510A and attaching base 520A. In FIG. 5B, the touchscreen guide is constructed of two components, tactile surface 510B having a groove for inserting the upper portion of attaching base 520B, which is flared to facilitated attachment to tactile surface 510B. In FIG. 5C, the touchscreen guide is constructed of two components, tactile surface 510C and attaching base 520C secured to the tactile surface 510C using an adhesive or silicon gel. Similarly, in FIG. 5D, the touchscreen guide is constructed of two components, the tactile surface 510D and attaching base 520D of similar width to the tactile surface 510D secured to tactile surface 510D using an adhesive or silicon gel.

The above description should not be construed as limitations on the scope of the invention, but rather as an exemplification of one preferred embodiment thereof. Many other variations are possible. Accordingly, the scope of the invention should be determined not by the embodiment(s) illustrated, but by the appended claims and their legal equivalents.

### Summary of Items Shown in the Drawings

| ITEM # | DESCRIPTION | FIG. # |
|---|---|---|
| 100 | Touchscreen Guide | 1 |
| 110 | Tactile surface | 1 |
| 120 | Attaching base | 1 |
| 130 | Electronic device | 1 |
| 140 | Touchscreen | 1 |
| 150 | Target area | 1 |
| 200A | Touchscreen Guide | 2 |
| 240A | Touchscreen | 2 |
| 250A | Target Area | 2 |
| 200B | Touchscreen Guide | 2 |
| 240B | Touchscreen | 2 |
| 250B | Target Area | 2 |
| 200C | Touchscreen Guide | 2 |
| 240C | Touchscreen | 2 |
| 250C | Target Area | 2 |
| 300A | Touchscreen Guide | 3 |
| 340A | Touchscreen | 3 |
| 350A | Target Area | 3 |
| 300B | Touchscreen Guide | 3 |
| 340B | Touchscreen | 3 |
| 350B | Target Area | 3 |
| 300C | Touchscreen Guide | 3 |
| 340C | Touchscreen | 3 |
| 350C | Target Area | 3 |
| 412A | Vertical Cross-section | 4 |
| 412B | Vertical Cross-section | 4 |
| 412C | Vertical Cross-section | 4 |
| 412D | Vertical Cross-section | 4 |
| 412E | Vertical Cross-section | 4 |
| 412F | Vertical Cross-section | 4 |
| 510A | Tactile Surface | 5 |
| 520A | Attaching Base | 5 |
| 510B | Tactile Surface | 5 |
| 520B | Attaching Base | 5 |
| 510C | Tactile Surface | 5 |
| 520C | Attaching Base | 5 |
| 510D | Tactile Surface | 5 |
| 520D | Attaching Base | 5 |

### Other Embodiments of the Invention

While the invention has been described in conjunction with the detailed description, the foregoing description is intended to illustrate and not limit the scope of the invention, which is defined by the scope of the appended claims. Other aspects, advantages, and modifications are within the scope of the following claims.

The specific methods and devices described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. The methods and processes illustratively described herein suitably may be practiced in differing orders of steps, and they are not necessarily restricted to the orders of steps indicated herein or in the claims.

As used herein and in the appended claims, the singular forms “a,” “an,” and “the” include plural reference unless the context clearly dictates otherwise. Under no circumstances may the patent application be interpreted to be limited to the specific examples or embodiments or methods specifically disclosed herein.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as described in the statements of the invention and as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the statements of the invention and the appended claims. In addition, the invention has been described broadly and generically herein. Each of the narrower species and subgeneric groupings falling within the generic disclosure also form part of the invention.

What is claimed is:

1. A touchscreen guide for demarcating a target area on an electronic touchscreen, wherein said touchscreen guide forms a raised border substantially surrounding said target area, and wherein said touchscreen guide comprises a tactile surface that provides tactile feedback to the user indicating the presence of said target area and an attaching base that removably attaches said touchscreen guide to said touchscreen.

2. The touchscreen guide of claim 1, wherein said touchscreen guide forms a circular border, an oval border, or an elliptical border surrounding said target area.

3. The touchscreen guide of claim 1, wherein said touchscreen guide forms a square border or a rectangular border surrounding said target area.

4. The touchscreen guide of claim 3, wherein said square border or rectangular border comprises rounded corners.

5. The touchscreen guide of claim 1, wherein said touchscreen guide forms a polygonal border surrounding said target area.

6. The touchscreen guide of claim 5, wherein said polygonal border comprises rounded corners.

7. The touchscreen guide of claim 1, wherein said tactile surface comprises an outer-side, an inner-side, and a top, and wherein said outer-side and said inner-side are oriented at about 90 degrees relative to said top.

8. The touchscreen guide of claim 7, wherein said outer-side and said inner-side are joined to said top at rounded corners.

9. The touchscreen guide of claim 1, wherein said tactile surface of said touchscreen guide has a curved shape.

10. The touchscreen guide of claim 1, wherein said guide forms an arch substantially surrounding said target area.

11. The touchscreen guide of claim 10, which has the shape of a horseshoe arch, elliptical arch, or parabolic arch.

12. The touchscreen guide of claim 1, wherein said tactile surface of said touchscreen guide comprises a metallic material.

13. The touchscreen guide of claim 1, wherein said tactile surface of said touchscreen guide comprises aluminum.

14. The touchscreen guide of claim 1, wherein said attaching base comprises rubber.

15. The touchscreen guide of claim 1, wherein said attaching base comprises neoprene rubber, isoprene rubber, silicone rubber, natural rubber, or any combination thereof.

16. The touchscreen guide of claim 1, wherein said attaching base is secured to said tactile surface using an adhesive.

17. The touchscreen guide of claim 1, wherein said tactile surface comprises a groove along its underside for insertion of said attaching base and said attaching base comprises a ridge for insertion into said tactile surface.

18. The touchscreen guide of claim 1, wherein said tactile surface has a curved cross section.

19. The touchscreen guide of claim 1, wherein said attaching base comprises a curved underside which enables removable attachment of said touchscreen guide to said touchscreen by suction.

20. The touchscreen guide of claim 1, wherein said attaching base comprises a microsuction film for removable attachment of said touchscreen guide to said touchscreen.
